(19) United States
(12) Patent Application Publication
(10) Pub. No.: US 2018/0367313 A1
(43) Pub. Date: Dec. 20, 2018

(54) SECURE MEMORY AND HIERARCHICAL STRUCTURE AND SYSTEM THEREFOR

(71) Applicant: Jakob Østergaard, Copenhagen (DK)

(72) Inventor: Jakob Østergaard, Copenhagen (DK)

(21) Appl. No.: 15/627,974

(22) Filed: Jun. 20, 2017

(51) Int. Cl. H04L 9/32; G06F 21/60

(52) U.S. Cl. CPC H04L 9/3236; G06F 17/30097; G06F 21/60

(57) ABSTRACT

An electronic device includes a processor capable of executing instructions. A memory is coupled to the processor. The memory includes instructions that when executed by the processor, causes the processor to receive a data object to be stored in memory. Next, the processor generates a hash value of at least a portion of the data object to be stored. The processor then assigns the hash value of the at least a portion of the data object as the filename of the data object. The data object is then written to an appropriate file in the memory identified by the file name.

### BACKGROUND OF THE INVENTION

### Field of the Invention

The present invention generally relates to data storage and, more particularly, to a secure hierarchical memory structure and novel dataset naming convention.

Data retrieval has become a more time consuming process than just a few years ago. With the myriad files of data, for example, photos, movies, documents, songs, etc. being stored on user devices and backup device, for example, servers, physical tape, spinning discs, etc. the ability to efficiently and seamlessly access, search, store and retrieve data has never been more important. Traditional backup solutions use a “grandfather, father, son” scheme where, for example, every month a full copy of all data, notwithstanding where the data is stored, would be made to a set of tapes or other suitable long term storage devices. Each week, a copy of the differences between the current dataset and the most recently monthly copy is made. Additionally, a copy of the difference between the current dataset and the most recent weekly copy of the dataset is made daily. Performing this much copying takes a significant amount of time to complete. Also, a large amount of unnecessary data storage is used (e.g. wasted) as, oftentimes, the differences between the current and previous datasets is minimal.

In addition to the excessive use of resources and the time required to store and retrieve data, data integrity and data loss issues also need to be addressed, In conventional backup and storage schemes, data values deteriorate over time which results in data being either partially unreadable or corrupted upon later retrieval. This time based deterioration is referred to as bit rot. To overcome the effects of bit rot, conventional storage protocols call for periodically copying all data from one storage medium to another, such that datasets are read in full before they are corrupted and re-written to another storage medium. Depending on the amount of data to be read and written, a significant amount of time and memory space will be used performing such operations.

### SUMMARY OF THE INVENTION

The present invention is directed to an electronic device including a processor capable of executing instructions. A memory is coupled to the processor. The memory includes instructions that when executed by the processor, causes the processor of the electronic device to receive a data object to be stored in memory. Next, the processor generates a hash value of at least a portion of the data object to be stored. The processor then assigns the hash value of the at least a portion of the data object as the filename of the data object. The data object is then written to an appropriate file in the memory identified by the file name.

To determine whether a file has been modified, the device calculates the hash value of the file in question and compares that hash value to a stored hash value. If the has values are the same, the file has not been modified; thereby

An advantage provided by the present invention is that searching, accessing and retrieving previously stored and/or modified files may be efficiently performed.

Another advantage provide by the present invention is that checksums or other error correction and detection steps are not required to confirm data integrity within the dataset.

Yet another advantage provided by the present invention is that renaming and moving files or directories does not result in the complete duplication of such data; thereby, significantly reducing the amount of physical space required when renaming and/or moving files or directories.

A feature provided by the present invention is that it does not require or take up additional hardware resources to implement.

Another feature provided by the present invention is that the naming scheme provides for more efficient use of underlying storage.

Yet another feature of the present invention is that data replication operations are much simpler to execute or otherwise perform as the stored objects are never modified.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a schematic block diagram of a data communication system, including the novel hierarchical memory structure according to an exemplary embodiment of the present invention;

FIG. 2 is a schematic block diagram of a client device, including the novel hierarchical memory structure according to an exemplary embodiment of the present invention;

FIG. 3 is a logical representation of a conventional data structure and naming convention;

FIG. 4 is a logical representation of the hierarchical data structure and naming convention according to an exemplary embodiment of the present invention;

FIG. 5 is a logical representation of the hierarchical data structure and naming convention according to an exemplary embodiment of the present invention when a portion of a dataset is copied to another position in memory;

FIG. 6 is a logical representation of the hierarchical data structure and naming convention according to an exemplary embodiment of the present invention when time snapshots of the root are taken; and

FIG. 7 is a flow chart illustrating the steps performed by a client device when naming and populating the hierarchical data structure according to an exemplary embodiment of the present invention.

### DETAILED DESCRIPTION OF THE INVENTION

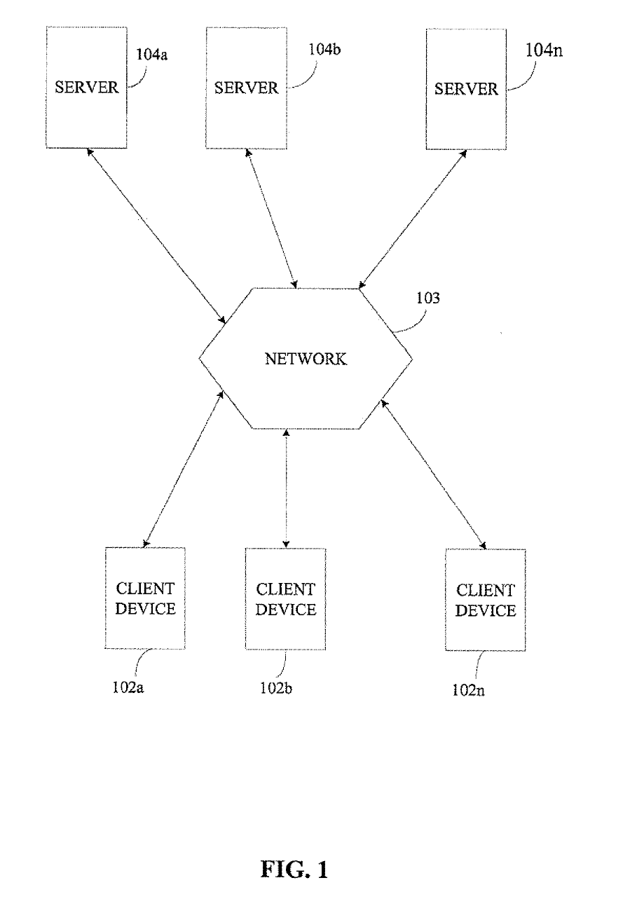

An exemplary embodiment of the present invention will now be described with reference to FIGS. 1-7. FIG. 1 is a schematic block diagram of a data communication system 100, including the novel hierarchical memory structure according to an exemplary embodiment of the present invention. As illustrated, one or more client devices 102a-102n, for example, laptop computers, desktop computers, palmtop computers, personal digital assistants, tablet computers, gaming consoles, mobile communication devices, for example mobile phones and other suitable devices are communicatively coupled to one or more servers 104a-104n via a network connection 103.

The network connection 103 may be a wide area network (WAN), local area network (LAN), Ethernet connection, 802.11a-n connection, an Internet connection or other suitable communication medium.

The one or more servers 104a-104n may include one or more memory devices configured for storing datasets and related information, for example, metadata corresponding to one or more users of the network. The one or more servers 104a-104n are configured to include the novel hierarchical memory (e.g. data tree) structure of the present invention configured to allow for easy access, searching, retrieving and transmission of relevant data to the one or more client devices 102a-102n connected to the network 103.

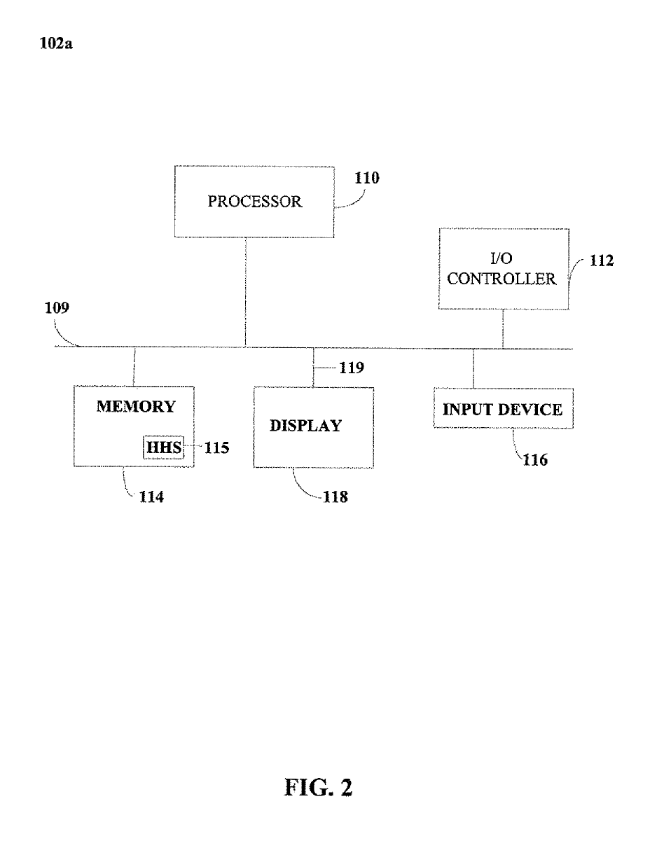

FIG. 2 is a schematic block diagram of a client device 102a, including the novel hierarchical memory structure according to an exemplary embodiment of the present invention. The client device 102a includes a processor 110, an input-output (I/O) controller 112, a memory 114, an input device 116 and a display 118. The display 118 may be, for example, a touch screen, a CRT display, an LED display or any suitable device capable of presenting information to a user of the client device 102a. The display 118 may be integrated within the client device 102a or may be externally coupled to the client device 102a through a suitable connection 119.

The processor 110 may be implemented, for example, by a microprocessor, a microcontroller, an application specific integrated circuit (ASIC), other suitable controller configured for controlling the functionality and operation of the client device 102a and to perform the computations necessary for providing the file naming and implementing the hierarchical memory architecture of the present invention.

The I/O controller 112 may include or be implemented by any suitable device, for example a transceiver (not shown) configured to provide for bi-directional communication between the client device 102a and one or more of the other client devices 102b-102n connected to the network 100 and/or to the one or more servers 104a-104n connected to the network. The I/O 112 controller may also be configured to transmit and/or receive data from one or more portable memory or information transmission and retrieval devices, for example, an SD card, a flash drive, a memory stick, a jump drive, a CD ROM drive, a DVD drive or other suitable portable memory device.

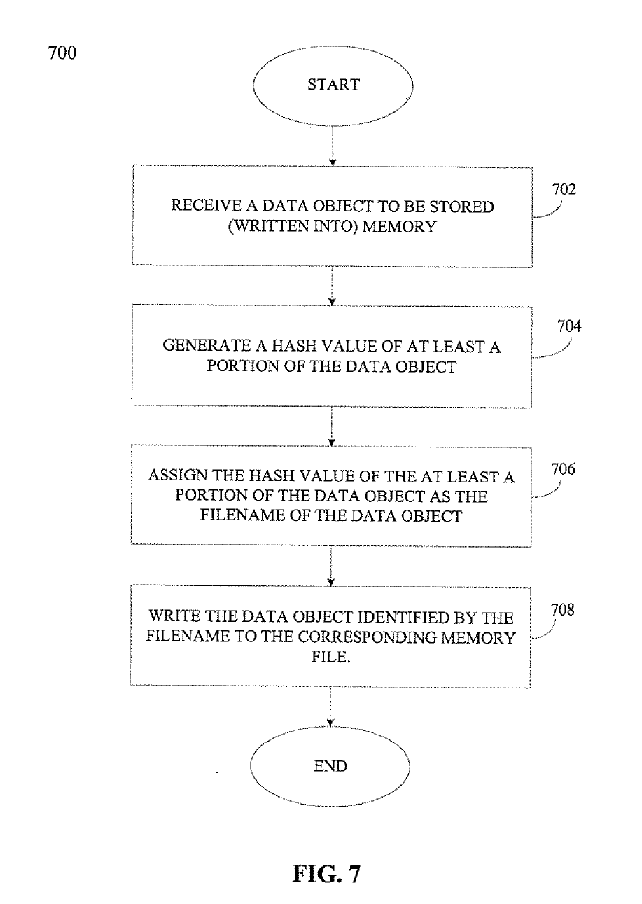

The memory 114 may include a random access memory (RAM), read only memory (ROM), dynamic random access memory (DRAM), electrically programmable read only memory (EPROM), electrically erasable and programmable read only memory (EEPROM) or other suitable non-transitory computer-readable medium capable of storing instructions that when executed by the processor 104, cause the processor 104 to perform the functional and operations steps to name the corresponding file and place the file within the hierarchical data structure 115 according to the present invention. The file naming and data structure generation steps will be described in greater detail below with respect to FIG. 7.

The input device 116 may be implemented, for example, by a keyboard, mouse, pointing device, touch pad or other suitable device capable of entering information into, extracting information from or searching for information on the client device 102a or the one or more servers 104a-104n. The processor 110, I/O controller 112, Memory 114 and input device are communicatively coupled via a system bus 119.

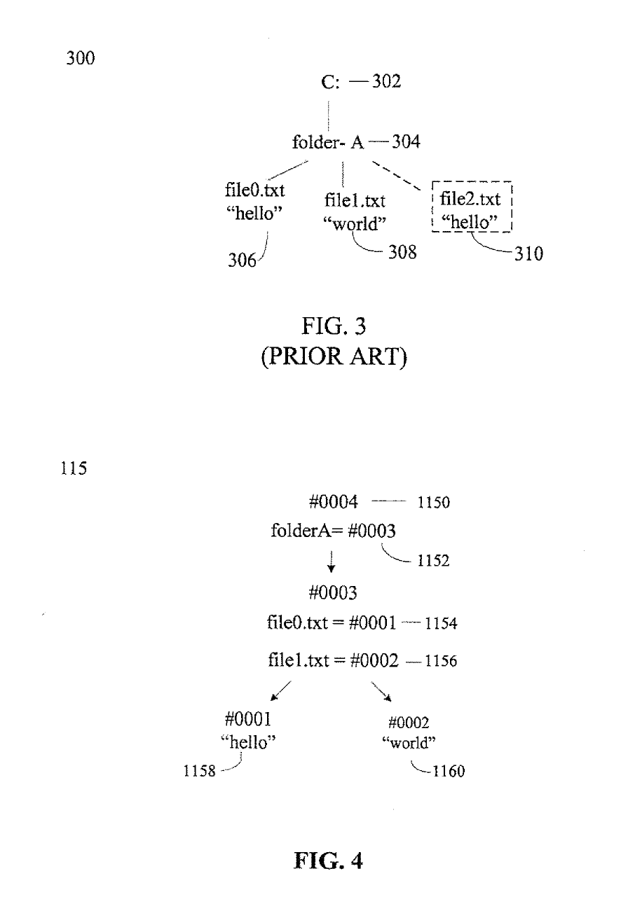

FIG. 3 is a logical representation of a conventional data structure 300 and naming convention implemented in memory. As illustrated, the data structure 300 includes a root 302, which would correspond, for example, to a hard drive on a client device or a memory included within a server device. The data structure 300 also includes a node 302, for example a folder (e.g. folder A) located on the hard drive. In application, the folder 302 is a generic container which may hold a list of files 306, 308 corresponding to data objects, for example, a document, photo, movie, song or other suitable piece(s) of information for storage and later retrieval. As illustrated, the files are named file0.txt 306, comprising the word “hello” and file1.txt 308, comprising the word “world”. The words “hello” and “world” comprise the content of the files file0.txt 306 and file1.txt 308, respectively. With the above implementation, it will be relatively easy to determine and access which files may be of interest to a third party (e.g. someone wanted to access user information without authorization) by reviewing the filenames, as filenames are typically related to the underlying data object. Thus, data security would be easily compromised.

Data storage usage may also become an issue with conventional memory structures. Referring to FIG. 3, let's look at the situation where the user copies file0.txt 306 into file1.txt 310. In this situation, two copies of the same content are stored in folder A 304. Depending on the size of file0.txt, a significant amount of memory resources may be used for a duplicate of the same file, e.g. file0.txt. When performing backup operations, for example, to a remote server, a copy of both file0.txt and file1.txt will be performed. In addition to copying redundant data, additional memory space is used for the multiple copies of the same information. This may result in additional copying time being used to perform the backup operation, as well as additional time required to search for a given piece of data (e.g. record), as multiple copies of the same data are collected and potentially having to be reviewed. This will have a negative effect on user experience. Moreover, memory expenses are increased as additional memory would be necessary when potentially having to store multiple copies of duplicate records.

FIG. 4 is a logical representation of the hierarchical data structure and naming convention 115 according to an exemplary embodiment of the present invention. As illustrated, the data structure is implemented as a tree structure, where the name of a particular file is comprised of a hash of the corresponding data object(s). For purposes of illustration, the computed hash value of data object 1158 “hello” is written as #0001 1154; the computed hash value of data object 1160 “world” is written as #0002 1156. The hash values 1154, 1156 are generated by the processor executing a 256-bit SHA-2 hash function on the data objects 1158, 1160, respectively. Other hash functions, for example, 128-bit, 384-bit or 512-bit SHA-2 or corresponding SHA-1 functions may also be used in alternate embodiments. In similar fashion, the name of a particular folder or node, for example, folder A 1152, is comprised of a hash value #0003 of the underlying filenames 1154, 1156. The hash values are typically at least 32-bytes in length such that hash collisions are statistically improbable. A benefit provided by the present invention is that verifying data (e.g. downloaded data) integrity is easily performed by computing the hash of a downloaded object and then compare that hash value with the name of the object to be downloaded. If the hash values are identical, the downloaded data is the same as the stored data. On the other hand, if the hash values are not identical, the downloaded data object is not the same (e.g. may have been modified) as the stored data. In this manner, the hash value serves as a checksum to confirm whether data objects have been modified.

The above-noted methodology may be extrapolated to secure the actual drive (e.g. hard drive on a client device or server), by naming the hard drive 1150 after a hash of the underlying folder(s) 1152 containing the data object 1158, 1160. Since each node (e.g. folder, file) in the tree structure is named after the hash of its corresponding contents, identical files or folders are not duplicated. They are simply referenced by multiple parents; thereby turning the tree structure into a Directed Acyclic Graph (DAG).

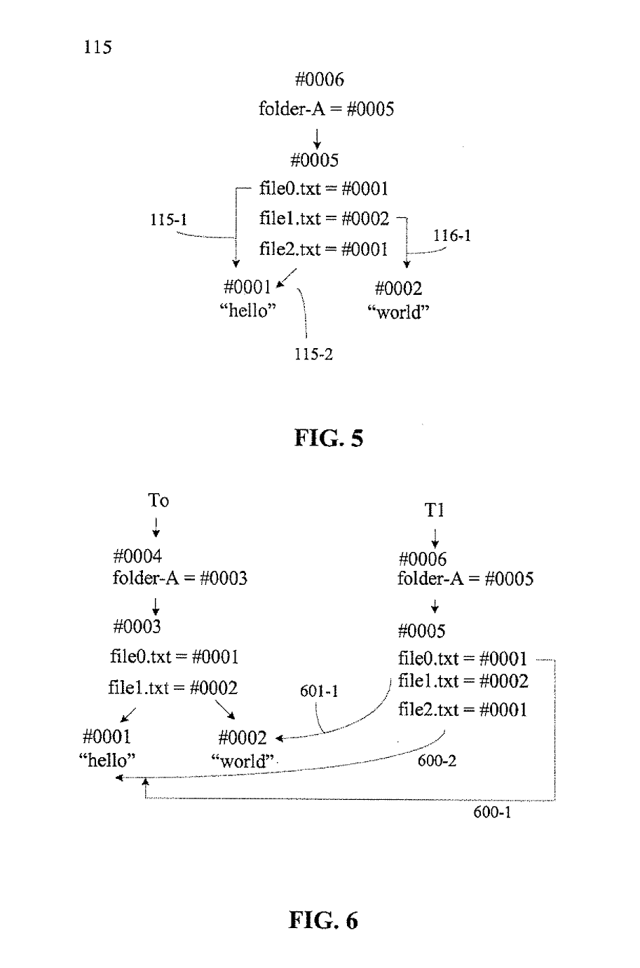

FIG. 5 is a logical representation of the hierarchical data structure and naming convention according to an exemplary embodiment of the present invention when a portion of a dataset, for example, file0.txt is copied to another file, for example, file2.txt in memory; thereby, making a duplicate of file0.txt. As illustrated, instead of creating a separate file for the copied data object, the original data object file0.txt is referenced two times 115-1, 115-2 from the parent directory. In this manner, security is maintained as the parent file points to the previously hash value #0001 of the data object. Memory space is also preserved in that the directory points to a previously populated location in memory—not creating a separate file for the copied data content.

By using pointers to one or more stable memory files, computing differences between trees becomes trivial. Only nodes (e.g. folders, files) where the hash value differs need to be visited, as an unchanged or otherwise unmodified hash value implies the entire subtree is unchanged. By implementing the tree structure and naming convention of the present invention, one can store arbitrary user backup trees in an object store, for example, a stable file store or document store, that simply support data objects named after the hash of their contents. Moreover, the integrity of a data object is easily confirmed by simply re-computing the hash of its contents. If the hash matches the object name, the data is intact and not otherwise corrupted. In this manner, a separate checksum or error detection step is not required to confirm data integrity within the dataset; thereby, increasing the efficiency of accessing and retrieving data. This has the beneficial effect of promoting efficient searching of backup data, for example, on a remote server as only comparisons of hash values need to be performed—not a potentially more meticulous (and time consuming) search of partial or complete name matches.

FIG. 6 is a logical representation of the hierarchical data structure and naming convention according to an exemplary embodiment of the present invention when time snapshots (e.g. T0-T1) of a root structure (or file) are taken. As new snapshots of the user's dataset are taken, more root entries 600-1 can be added to the DAG, effectively re-using and re-referencing already existing unchanged nodes in the graph. The computer program running on the user's device will cause the processor, or suitable controller, to traverse the user's device for data changes and generate the subset of the DAG for the snapshot, for example entry 600-1, as needed. In a client/server system, the client device software will query the server software if a data object with a given hash already exists. If the hash already exists, there is no need to upload the data object. If the hash does not exist, the data object may be uploaded. This effectively provides for data de-duplication during the upload itself, without the client device having any prior knowledge of which data objects reside on the server. Traditional de-duplication works only on servers and does not prevent re-upload of data objects that will later be de-duplicated.

Since no prior information about the existing data set is necessary at the client device in order to perform de-duplication, the de-duplication domain can be chosen wider than what would normally be applicable. For purposes of illustration and not limitation, the de-duplication domain is the set of data against which new data is de-duplicated. As the present invention stores data objects named after the hash value of their corresponding contents, the present invention will de-duplicate all data stored in the same underlying storage system. For example, if you have two underlying storage systems, System A and System B and you have five customers (p, q, r, s, t) for which data is to be stored, we would store data from customers p, q, and r on System A and from customers s and t on System B, then customers p, q and r would share one de-duplication domain and customers s and t would share a another de-duplication domain. If the client device attempts to upload a data object, it first computes the hash value of the data object and queries the server (or plurality of servers if there are more than one) regarding whether an object having that hash value is currently present on the server. If the hash value is present on the server, uploading is not performed. Otherwise, the data object is uploaded to the server.

In systems where there is a restriction on memory size, if the data objects exceeds the maximum size, the corresponding files may be divided into smaller sizes or pieces—which then become individual objects—and the container, or reference file, will then reference a list of hash values rather than a single hash value. This allows for better de-duplication and for especially for large files, for example, a large database that are modified only partially, another upload of the file will only involve up-loading the actual changed pieces—not the entire file.

Implementing the protocol of the present invention, promotes advanced optimizations that may be extremely difficult and very costly to achieve in conventional systems employing conventional naming protocols; therefore, not at all likely to be used in conventional systems. For example, the renaming and moving of files will not result in duplicated data. Only the necessary folder meta-data will be updated, along with folder meta-data objects back to the root of the tree. Resurrecting data that exists in old backup sets, for example, restoring previously deleted data from an external drive, will not result in the re-upload of the data. The data is recognized, for example, comparison of the hash values, and simply re-references (e.g. additional pointer to the data) in the DAG. Moreover, the server-side can treat the data as immutable. As every data object is named after the hash of its contents, no object is ever modified and no object is ever deleted. This provides for significant optimizations on the server-side.

Periodically, a user or corporate entity may wish to reduce, or trim, the snapshot history of a particular user to limit the amount of historical data retained. By discarding references to roots in the DAG (e.g. the snapshot time entries), these data objects are no longer referenced and the snapshots become effectively unreachable. By periodically traversing the reachable roots of the DAG and coping the data objects to other storage systems, two important effects are achieved: (1) upon completion of copying, all reachable data objects are safely copied to a secondary system; and (2) the original storage system can be deleted in full which can be an extremely simple operation. The deletion of the original system will free up any data objects that are no longer referenced by any reachable snapshot entries; effectively deleting unneeded data without maintaining reference counts or other sophisticated data management approaches which may be costly and time consuming. Moreover, the periodic copying of the user's full dataset solves the problem of bit-rot (e.g. data integrity degradation) in that re-writing of data objects becomes a natural and integral part of the storage solution.

FIG. 7 is a flow chart illustrating the steps performed by the processor 102 (FIG. 1) of the client device 100 (FIG. 1) when naming and populating the hierarchical memory data structure 115 (FIG. 1) according to an exemplary embodiment of the present invention. The steps illustrated in FIG. 7 may be encoded in any suitable programming language and stored in a non-transitory computer readable medium. The non-transitory computer readable medium may be located in a suitable client device 102a (FIG. 1), but may also be located within one or more server devices 104a (FIG. 1) capable of maintaining datasets for long periods of time. In application, the non-transitory computer readable medium is coupled to the processor of the client device or server device and maintains the instructions, that when executed by the processor, causes the relevant processor to execute or otherwise perform the steps encoded therein as discussed in greater detail below.

The method begins at step 702, where a data object to be stored (e.g. written to) in memory is received. This may be accomplished, for example, by the processor receiving a data object or a larger dataset from a corresponding input device 116 (FIG. 1) or from one or more client or server devices over the network 103 (FIG. 1).

In step 704, a hash value of at least a portion of the received data object is generated. This may be accomplished, for example, by the processor 102 (FIG. 1) applying a 256-bit SHA-2 hash function to the data object, resulting in hash of the data object being generated. In a principal embodiment, the hash of the entire data object is generated. The resulting value is a 32-bit representation of the data object, thereby making collisions with other data statistically improbable.

In step 706, the hash value of the at least portion of the data object is assigned as the file name of the data object. In this manner, the file name includes a portion of the hash of the actual dataset content. Moreover, determining whether the contents of the corresponding data object or file have been modified or removed is just a matter of generating a hash value of a data object (or filename) and comparing the generated hash value is equal to the stored hash value. If the hash values are equal, the corresponding data object has not been modified; therefore, no updating needs to be performed. If the hash values are not equal, the corresponding data object has been modified or potentially moved. In this situation, a pointer to the modified data object is established, or the data object is stored in the corresponding file.

In step 708, the data object identified by the filename is written to the corresponding memory file. This may be accomplished, for example, by the processor writing the data object into the corresponding memory file or container. In an exemplary embodiment, the memory file may be identified as a hash of the contents to be stored therein. In this manner, the security of the memory files, as well as the integrity of the underlying data objects are enhanced. The process then ends.

Although the above detailed description of the invention contains many details, these should not be construed as limiting the scope of the invention but as merely providing illustrations of some of the presently exemplary embodiments of this invention. Therefore, it will be appreciated that the scope of the present invention fully encompasses other embodiments which may become obvious to those of ordinary skill in the art, and that the scope of the present invention is accordingly to be limited by nothing other than the claims appended hereto.

What is claimed is:

1. A client device, comprising:
a processor;
a memory, coupled to the processor, the memory including instructions that when executed by the processor, cause the processor to:
receive a data object to be stored in memory,
generate a hash value of at least a portion of the data object,
assign the hash value of the at least a portion of the data object as the filename of the data object, and
write the data object identified by the filename to an appropriate file in memory.

2. The client device of claim 1, wherein the hash value is at least 32 bytes in length.

3. The client device of claim 1, wherein the hash value is greater than 32 bytes in length.

4. The client device of claim 1, wherein the hash value is less than 32 bytes in length.

5. The client device of claim 4, wherein the hash value is 16 bytes in length.

6. The client device of claim 1, wherein the file is identified as a hash value of the filenames of one or more data objects stored therein.

7. The client device of claim 3, wherein the memory includes a data structure including a node, the node having one or more data objects stored therein, wherein the node is assigned a name comprising a hash of its contents.

8. The client device of claim 7, wherein the data objects are stored in one or more files, each of the one or more files identified by a hash of at least a portion of the data objects stored therein.

8. The client device of claim 1, wherein the memory further includes instructions, which when executed by the processor, cause the processor to: (a) receive a second data object to be stored in memory; (b) calculate a hash value of the second data object; and (c) compare the hash value of the second data object with the other hash values stored in the memory, wherein, if the hash value of the second data object is the same as a previously stored hash value, provide a pointer from the memory to the previously stored hash value.

9. The client device of claim 1, wherein the memory further includes instructions, which when executed by the processor, causes the processor to: (a) receive a second data object to be stored in memory; (b) calculate a hash value of the second data object; and (c) compare the hash value of the second data object with the other hash values stored in the memory, wherein, if the hash value of the second data object is different from a previously stored hash value, writing the second object to the appropriate file in memory.

10. A non-transitory computer readable medium having stored thereon a set of computer-executable instructions executable by a processor for causing the processor to perform operation, comprising:
receiving a data object to be stored in memory,
generating a hash value of at least a portion of the data object,
assigning the hash value of the at least a portion of the data object as the filename of the data object, and
writing the data object identified by the filename to an appropriate file in memory.

11. The non-transitory computer readable medium of claim 10, further including instructions for (a) receiving a second data object to be stored in memory; (b) calculating a hash value of the second data object; and (c) comparing the hash value of the second data object with the other hash values stored in the memory, wherein, if the hash value of the second data object is the same as a previously stored hash value, providing a pointer from the memory to the previously stored hash value.

12. The non-transitory computer readable medium of claim 10, further including instructions for (a) receiving a second data object to be stored in memory; (b) calculating a hash value of the second data object; and (c) comparing the hash value of the second data object with the other hash values stored in the memory, wherein, if the hash value of the second data object is different from a previously stored hash value, writing the second object to the appropriate file in memory.

13. The non-transitory computer readable medium of claim 10, including a data structure comprising a node, the node having one or more data objects stored therein, wherein the node is assigned a name comprising a hash of its contents.

14. The non-transitory computer readable medium of claim 13, wherein the data objects are stored in one or more files, each of the one or more files identified by a hash of at least a portion of the data objects stored therein.

15. A method comprising the steps of:
receiving a data object to be stored in memory,
generating a hash value of at least a portion of the data object,
assigning the hash value of the at least a portion of the data object as the filename of the data object, and
writing the data object identified by the filename to an appropriate file in memory.

16. The method of claim 15, further including the steps of:
receiving a second data object to be stored in memory;
calculating a hash value of the second data object; and
comparing the hash value of the second data object with the other hash values stored in the memory, wherein, if the hash value of the second data object is the same as a previously stored hash value, providing a pointer from the memory to the previously stored hash value.

17. The method of claim 15, further including the steps of:
receiving a second data object to be stored in memory;
calculating a hash value of the second data object; and
comparing the hash value of the second data object with the other hash values stored in the memory, wherein, if the hash value of the second data object is different from a previously stored hash value, writing the second object to the appropriate file in memory.
